(19) United States
(12) Patent Application Publication
(10) Pub. No.: US 2008/0303691 A1
(43) Pub. Date: Dec. 11, 2008

(54) Hybrid automotive fluid dispensing system

(75) Inventor: Eric Krassinger, St. Louis, MO (US)

Correspondence Address: SENNIGER POWERS LLP, 100 NORTH BROADWAY, 17TH FLOOR, ST LOUIS, MO, 63102, US

(73) Assignee: LINCOLN INDUSTRIAL CORPORATION, St. Louis, MO (US)

(21) Appl. No.: 11/759,650

(22) Filed: Jun. 7, 2007

(51) Int. Cl. H02J 13/00; F16K 21/16; G06Q 10/00

(52) U.S. Cl. 340/825.52; 137/251.1; 705/1; 705/29

(57) ABSTRACT

A fluid dispensing control system comprising a plurality of hybrid fluid dispensing units and hybrid keypads are capable of both wired and wireless communication with a billing computer.

### BACKGROUND OF THE INVENTION

As automotive dealership management systems become more and more sophisticated, these systems begin to interface with other systems in the automotive dealership. For example, the parts management and acquisition system interfaces with the automotive dealership management system. In addition, the various fluid delivery systems used within the automotive dealership interface with the management system. There is a need for these systems to be more integrated and easier to implement and install so that the full operation and management of the automotive dealership can be accomplished seamlessly and without undue effort.

Most automotive businesses which are involved in sales and/or service use a computer-based system to manage inventory and repair orders. Such systems, frequently referred to as dealership management systems or DMS, vary in size and complexity depending on the size and needs of the particular automotive business. In addition, a DMS interfaces with other systems at various levels. For example, a DMS may receive or provide certain information to other systems such as a fluid dispensing system, a parts management system and/or a repair order scheduling system. As noted above, there is a need for better integration of information between a DMS and a fluid dispensing system.

In addition, there is a need for a fluid dispensing system which is easy to install and implement and which is simple in use so that the various operators of the system can take full advantage of the system without the need for overrides or unnecessary effort. There are many reasons to integrate the fluid management system of a service shop into the shop's DMS accounting software. Some of these reasons are: automate billing process, dispense only valid repair orders, manage lubricant inventory, increase service bay efficiency, and prevent misallocation of product. Benefiting owners, service managers, parts managers and mechanics, an integrated fluid control system saves time and money through automated billing and by creating a smooth flow throughout the operation of the shop. Ease of installation and management of the fluid control system including customizing its installation and location of its various parts allows mechanics controlled access to lubricants or other fluids without leaving their bays. Dispensing events are captured instantly and automatically to eliminate manual entering and errors. Accounting functions are completed accurately on the repair order and invoice, recording inventory depletion and eliminating lost billings.

### SUMMARY OF THE INVENTION

The fluid dispensing control system according to one embodiment of the invention includes a plurality of hybrid fluid dispensing units and/or hybrid keypads providing both wired and wireless communication with a billing computer.

Other objects and features will be in part apparent and in part pointed out hereinafter.

### BRIEF DESCRIPTION OF THE DRAWINGS

FIG. 1 is a block diagram of one embodiment of a dispensing unit according to the invention in combination with a lubricant delivery system and a master PC in which the dispensing unit is capable of being configured to communicate with the master PC via a hard-wired (solid line) Ethernet network or via a wireless communication link (dashed line).

FIG. 2 is a block diagram of one embodiment of a dispensing unit according to the invention in combination with a solenoid valve and pulse meter in which the dispensing unit is capable of being configured to communicate via a hard-wired Ethernet network or via a wireless communication link.

FIG. 3 is a block diagram of one embodiment of a dispensing unit according to the invention in combination with a master PC in which the dispensing unit is configured to communicate with the master PC via a wireless communication link (dashed line) and wherein the dispensing unit may function as a router for hard-wired Ethernet communication with a second dispensing unit or keypad (see FIG. 8).

FIG. 4 is a block diagram of a system according to the invention employing only a hard-wired (solid lines) Ethernet network to interconnect keypads, dispensing units and a master PC, wherein the keypads are networked by hard-wire connection via the dispensing units and wherein the master PC is networked by hard-wire connection via one of the dispensing units.

FIG. 5 is a block diagram of a system according to the invention employing only a hard-wired Ethernet network to interconnect keypads, dispensing units, wired hubs and a master PC wherein the keypads are networked by hard-wire connection via the dispensing units and via wired hubs, wherein dispensing units are networked by hard-wire connection via wired hubs and via other dispensing units and wherein the master PC is networked by hard-wire connection via one of the dispensing units.

FIG. 6 is a block diagram of a system according to the invention employing both wireless communication links (dashed lines) and a hard-wired (solid lines) Ethernet network to interconnect keypads, dispensing units, wireless switches and a master PC, wherein most of the keypads and most of the dispensing units are networked via a wireless communication link (dashed lines) to the wireless switches, wherein the two of the dispensing units 604 and two of the keypads 606 are networked by hard-wire connection (solid lines) via the wireless switches, and wherein the wireless switches and master PC are networked via a wideband wireless communication link (slashed lines).

FIG. 7 is a block diagram of a system according to the invention employing both a wireless communication link and a hard-wired Ethernet network to interconnect keypads, dispensing units, wireless switches and a master PC, wherein the keypads are networked by hard-wire connection (solid lines) via the wireless switches or via the dispensing units, wherein the dispensing units are networked by hard-wire connection (solid lines) via another dispensing unit or via the wireless switches, and wherein the wireless switches and master PC are networked via a wideband wireless communication link (slashed lines).

FIG. 8 is a block diagram of a system according to the invention employing both a wireless communication link (dashed lines) and a hard-wired (solid lines) Ethernet network to interconnect keypads, dispensing units, and a master PC, wherein some of the dispensing units function as both a router and a dispensing unit (herein router/dispensing units), wherein some of the keypads are networked to the router/dispensing units by hard-wire connection (solid lines), wherein some of the keypads are networked to the dispensing units via hard-wire (solid lines), wherein the dispensing units are networked to the router/dispensing units or to the master PC by hard-wire connection (solid lines), and wherein the router/dispensing units and master PC are networked via a wireless communication link (dashed lines).

FIGS. 9A-9E are screen shots of one embodiment of software instructions executed by the master PC to confirm the connectivity to the dispensing units and keypads.

FIGS. 10A-10H are screen shots of one embodiment of software instructions for uploading software to the dispensing units and keypads.

FIGS. 11A-11F are screen shots illustrating software instructions for ftp tank monitoring.

FIG. 12 is a block diagram of one embodiment of a keypad according to the invention.

FIG. 13 is a diagram of one embodiment of a circuit for confirming the connections to the solenoid and the pulse meter.

Corresponding Reference Characters Indicate corresponding parts throughout the drawings.

### DESCRIPTION OF THE PREFERRED EMBODIMENTS

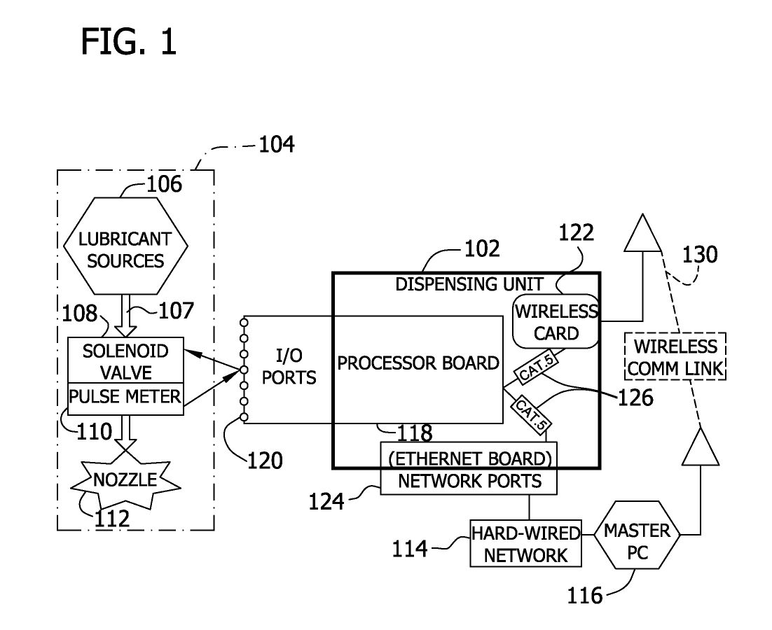

FIG. 1 is a block diagram of one embodiment of a fluid dispensing unit according to the invention in combination with a lubricant delivery system and a computer, such as a billing computer, frequently, a master personal computer (PC). The dispensing unit is capable of being configured to communicate with the master PC via a hard-wired network (solid line; such as “a proprietary Ethernet network”) or via a wireless communication link (dashed line). As described herein, the hard-wired network will be referred to as an Ethernet network. However, it is contemplated that any hard-wired network may be employed. The network is referred to as “a proprietary Ethernet network” to distinguish it from the dealership Ethernet network which connects various computers, printers and other devices of the dealership. The proprietary Ethernet network of the invention is separate from the dealership Ethernet network. A noted below, a master PC may provide a node which is located between the proprietary Ethernet network and the dealership Ethernet network.

A dispensing unit 102 is used in combination with a lubricant delivery system 104 for controlling lubricant to be delivered by a mechanic. For example, the lubricant delivery system 104 may have a plurality of lubricant sources 106 such as 55 gallon drums of various grades of oil. Each lubricant source 106 supplies the lubricant via a hose reel 107 having an in-line valve such as a solenoid valve 108 controlling flow and having a sensor such as a pulse meter 110 sensing lubricant flow. The hose terminates in a nozzle 112 operated by the mechanic. The dispensing unit 102 opens and closes the solenoid 108 in response to instructions received via a network 114 to which the dispensing unit 102 is connected, as noted below, to selectively allow the dispensing of lubricant. The pulse meter 110 measures the amount of fluid dispensed and provides signals to the dispensing unit 102 indicative of the amount of dispensed fluid. Dispensed fluid information (e.g., volume and type of fluid dispensed) would be provided by the dispensing unit 102 via the network 114 to a master computer (PC) 116.

The network 114 would include a plurality of dispensing units 102 and at least one computer such as a billing computer, referred to herein generally as master PC 116, which would communicate with each of the dispensing units 102. The network may also include other components as noted below.

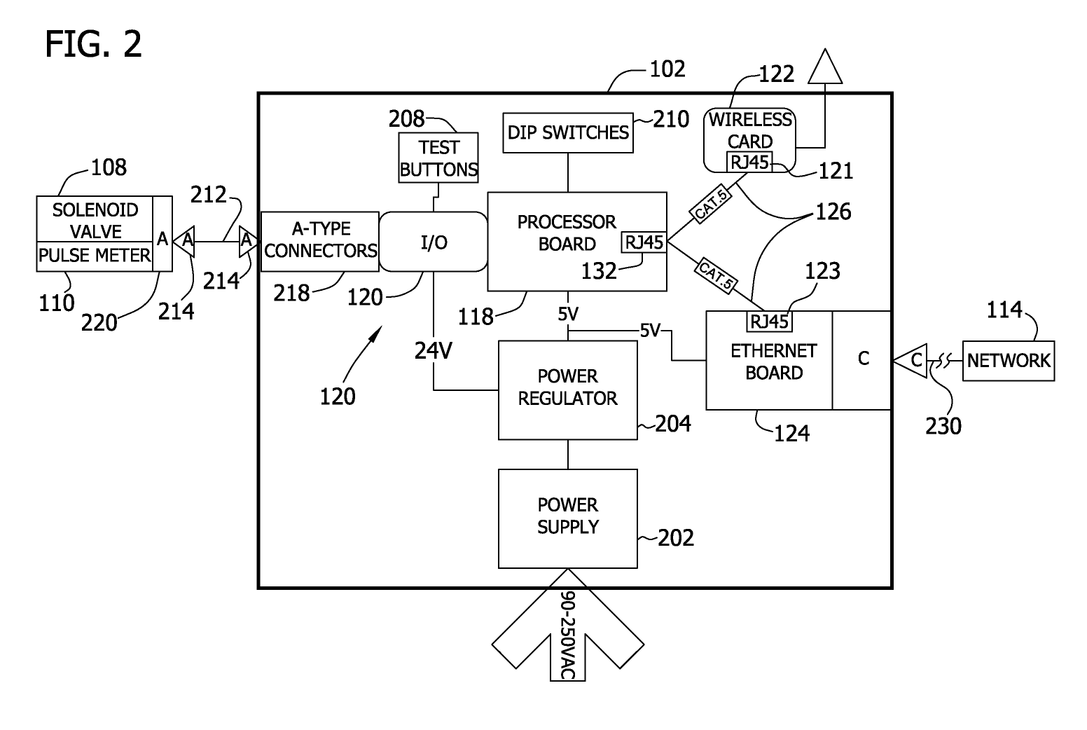

As illustrated in FIGS. 1 and 2, a dispensing unit housing would enclose a processor board 118 including a plurality of I/O (input/output) ports 120, each port 120 for interfacing with a lubricant source 106 and in particular interfacing with the solenoid valve 108 and pulse meter 110 controlling the flow of the particular lubricant source 106. For example, in one embodiment it is contemplated that the dispensing unit 102 would have six I/O ports 120 for controlling six different hose reels supplying six different types of lubricant. Each port would have a solenoid valve connection and a pulse meter connection, as noted below.

The dispensing unit housing would also include a wireless card 122 and an Ethernet board 124, either of which may be used for communicating with the master PC 116. In one embodiment, a connecting device 126 such as Category 5 (CAT. 5) cable or other Ethernet cable may link a data port 132 terminating in an RJ45 connector of the processor board 118 and a data port 123 terminating in an RJ45 connector of the Ethernet board 124 so that the dispensing unit 102 would be connected to the hard-wired network 114 and communicate via hard-wire Category 5 connections to the master PC 116. Alternatively, the connecting device 126 may be a CAT. 5 cable interconnecting the data port 132 of the processor board 118 and a data port 121 terminating in an RJ45 connector of the wireless card 122 so that the dispensing unit 102 would communicate with the master PC 116 via a wireless communication link 130 using any wireless protocol, such as 802.11b WiFi. Thus, the dispensing unit 102 is referred to as a hybrid dispensing unit because it is capable of communicating via hard-wire network connections through the hard-wire ports of the Ethernet board 124 or via a wireless communication connection such as WiFi via the wireless card 122. Similarly, as used herein, a hybrid system is a system that includes both wired and wireless communications. Depending on the location of the dispensing unit within a shop relative to the master PC 116, the dispensing unit 102 is capable of being configured to communicate with the master PC 116 via a hard-wired internet network 114 illustrated by solid lines or is capable of being configured to communicate with the master PC 116 via a wireless communication link 130 illustrated by dashed lines. For example, the hard-wired network 114 may be used to communicate with the master PC 116 when the dispensing unit 102 is outside the WiFi area or is subject to excessive interference. On the other hand, a wireless communication link 130 may be used when the dispensing unit 102 is located in a place which is difficult to reach by a hard-wired connection.

Thus, FIG. 1 illustrates one embodiment of a hybrid fluid dispensing control unit 102 for connecting to a wired network 114 interconnecting other fluid dispensing control units (not shown in FIG. 1) and a billing computer such as the master PC 116. It is contemplated that the master PC 116 would be connected to the network 114 via hard-wire or via a wireless communication device (e.g., wireless card 122) for receiving wireless signals via communication link 130. The dispensing unit 102 includes processor board 118 having I/O ports 120 for controlling solenoid valves 108 for dispensing fluid and having data port 132 for transmitting and receiving information. In addition, the dispensing unit 102 includes an Ethernet board 124 having hard-wire ports for connecting to the wired network 114 and communicating with the master PC 116. In addition, the dispensing unit includes a wireless communication device such as wireless card 122 for communicating with the master PC 116 via a wireless communication link 130. A connecting device 126 selectively connects the data port 132 to either the Ethernet board 124 or the wireless card 122 for communicating with the master PC 116.

FIG. 2 is a block diagram of one embodiment of the dispensing unit 102 according to the invention in combination with the solenoid valve 108 and pulse meter 110 in which the dispensing unit 102 is capable of being configured to communicate via the hard-wired Ethernet network 114 or via the wireless communication link 130. As shown in more detail with regard to FIG. 2, the dispensing unit 102 includes a power supply 202 and a power regulator 204 for supplying power to both the Ethernet board 124 and the processor board 118. Connected to the processor board 118 is an input/output (I/O) device which provides the I/O ports 120 for connection to the solenoid valves 108 and pulse meters 110. Connected to the I/O ports 120 is a plurality of test buttons 208, one for each solenoid valve 108 and pulse meter 110 port. In general, the I/O device is configured so that when a test button 208 is manually pushed to close a switch, the solenoid valve 108 of that port is also energized to open to manually test that the solenoid valve does open and to confirm that the pulse meter 110 associated with the solenoid valve 108 is measuring fluid being dispensed through the solenoid valve 108. In addition, the dispensing unit 102 includes a plurality of dip switches 210 connected to processor board 118 which define a unique address for the particular dispensing unit 102 whether it is part of the hard-wired network 114 or part of the wireless communication link 116, in order to permit the processor board 118 to communicate with the master PC 116. So that each dispensing unit 102 has a unique address, the dip switches 210 of each dispensing unit communicating with the master PC 116 are positioned differently so that the positions of the dip switches define a TCPIP address of the processor board 118 unique to the network or communication link to which the other dispensing units and the master PC 116 are connected.

In one embodiment according to the invention, connectors for receiving wires which connect the I/O ports 120 with the solenoid valves 108 and pulse meters 110 are different than and incompatible with connectors for receiving wires which are part of the hard-wired network 114 and connect to the Ethernet boards 124. This insures that the various wires connected to the dispensing unit 102 can only be connected to the appropriate port. This prevents an Ethernet cable being connected to the I/O ports 120 or a solenoid/pulse meter cable being connected to an Ethernet board. For example, as illustrated in FIG. 2, a cable 212 is shown to be connected between one of the I/O ports 120 to the solenoid valve 108 and the pulse meter 110. Such a cable would have a type A cable connector 214 at each end. In addition, the I/O ports 120 of the dispensing unit 120 would be configured to have type A connectors 218 for each of the I/O ports 120. In addition, the solenoid valve 108 and pulse meter 110 combination would be configured to have a type A connector 220.

Thus, the cable 212 would connect to the I/O port 120 and to the combined ports of the solenoid valve 108 and pulse meter 110 as no other locations on the dispensing unit 102 or within the network to which the dispensing unit 102 is connected would have type A connectors. As a further example, the hard-wire ports of the Ethernet board 124 may be connected to the network 114 via a hard-wire cable 230 which would terminate in C type connectors. The hard-wire ports of the Ethernet board 124 would also have C type connectors so that the cable 230 of the hard-wired network would only be permitted to be connected to the Ethernet boards of the dispensing units 102. In this example, the connectors C would be different from and incompatible with the connectors A and visa versa so that the Ethernet board cable 230 could not be connected to the I/O ports 120 and so that the cable 230 could not be connected to the combined ports of solenoid valve 108 and pulse meter 110. Similarly, the cable 212 for interconnecting the I/O ports 120 and the combined ports of the solenoid valve 108 and pulse meter 210 could not be connected to the hard-wire ports of the Ethernet board 124.

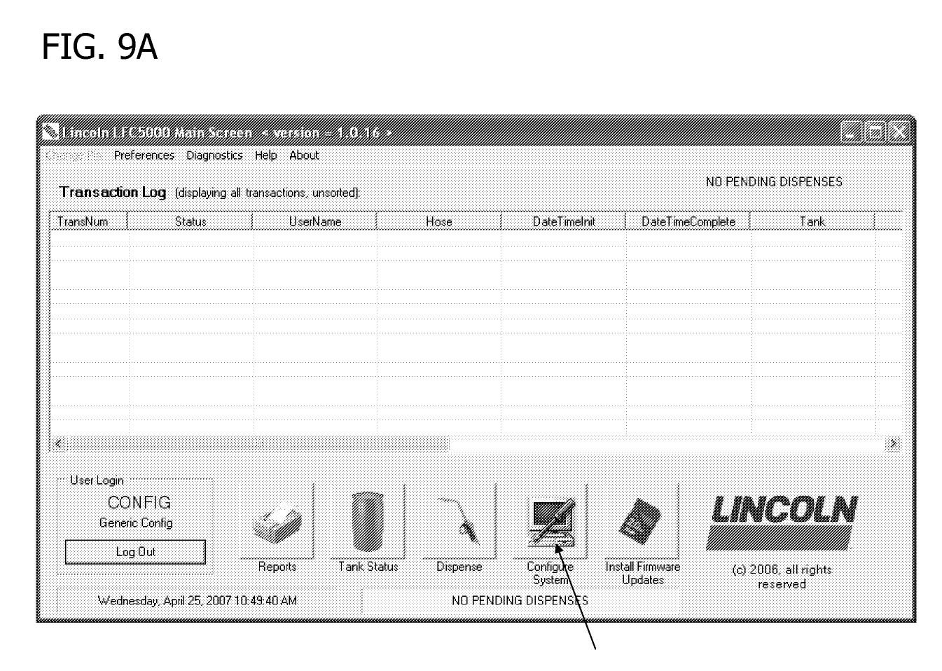

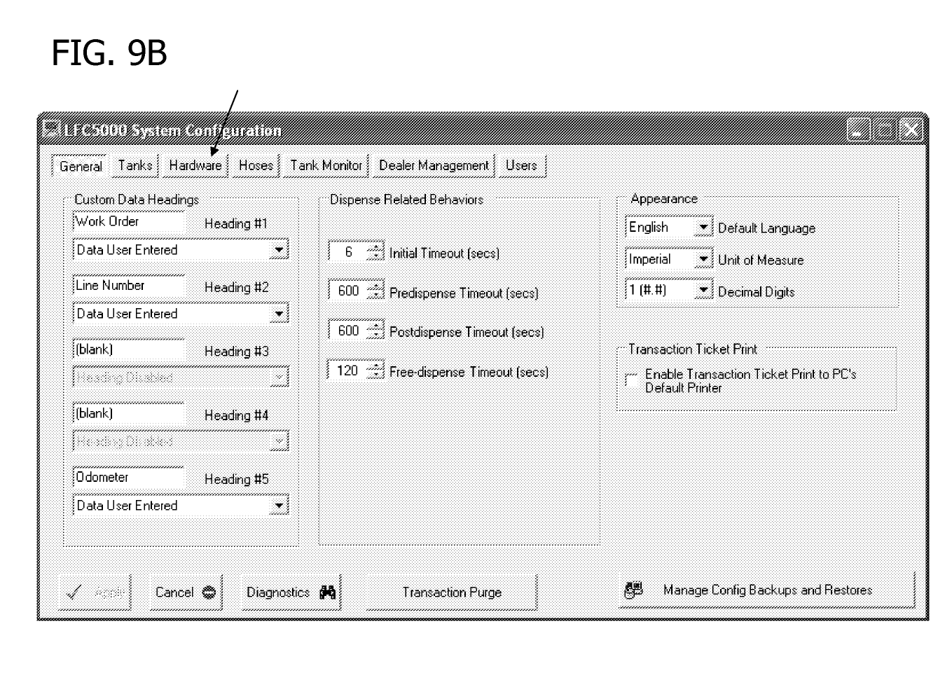

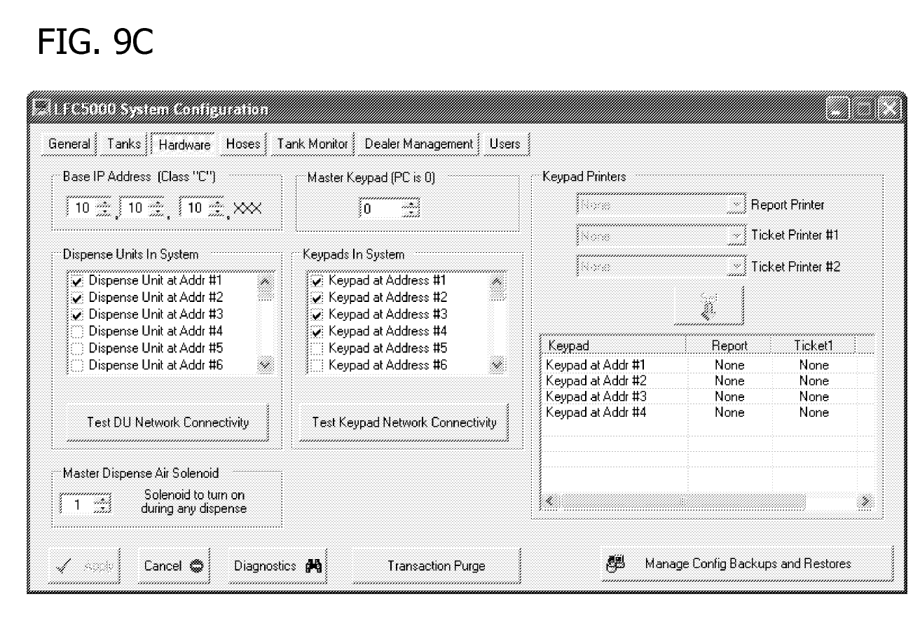

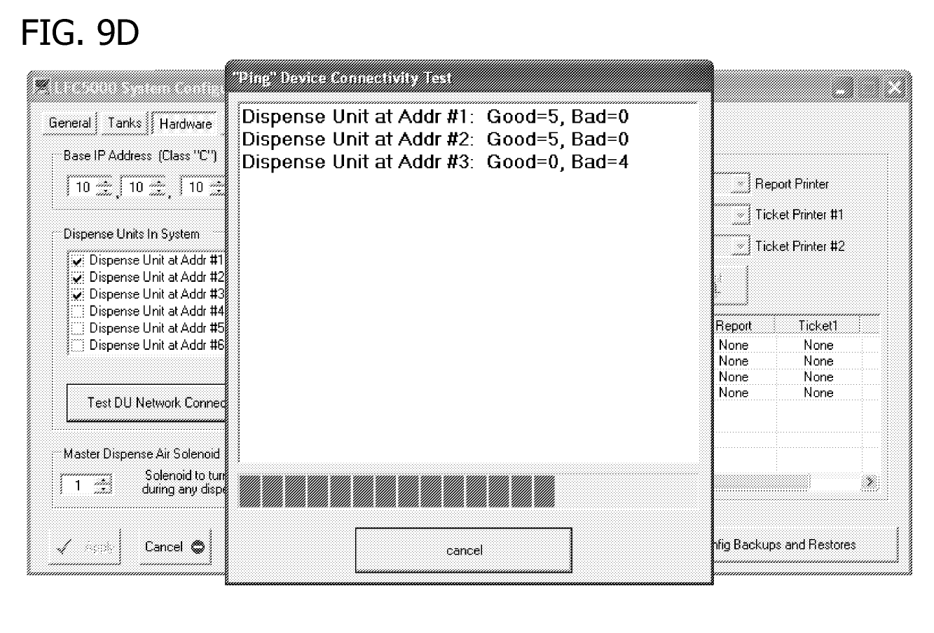

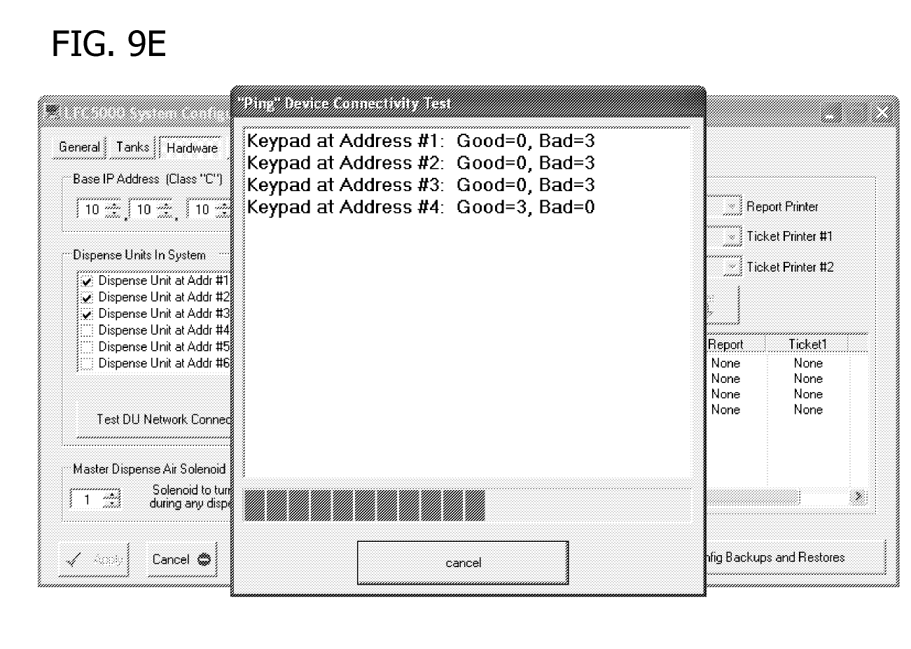

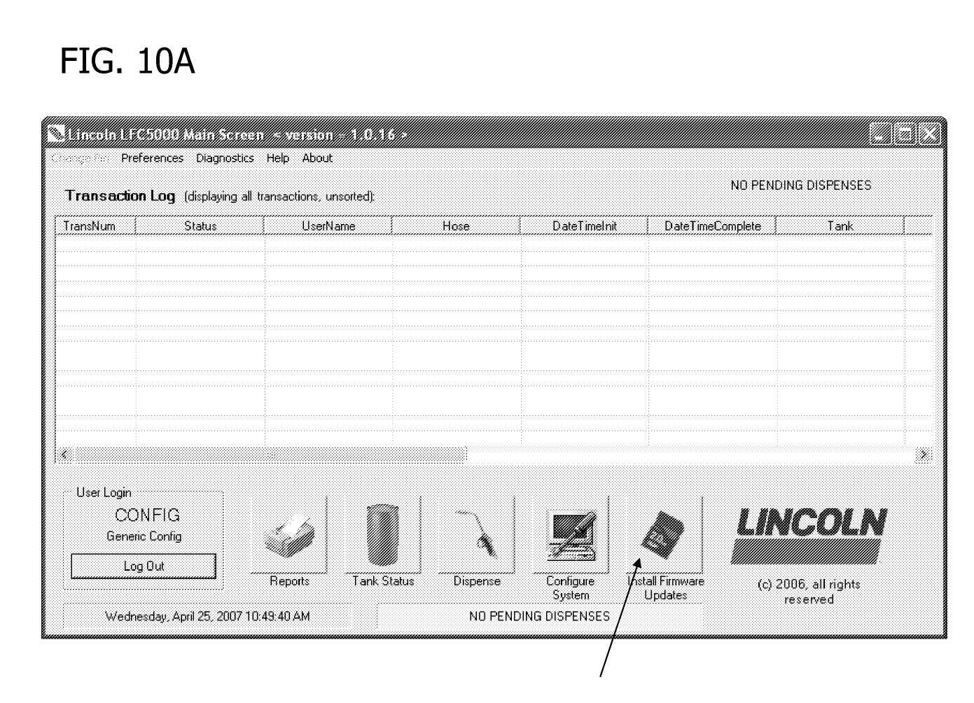

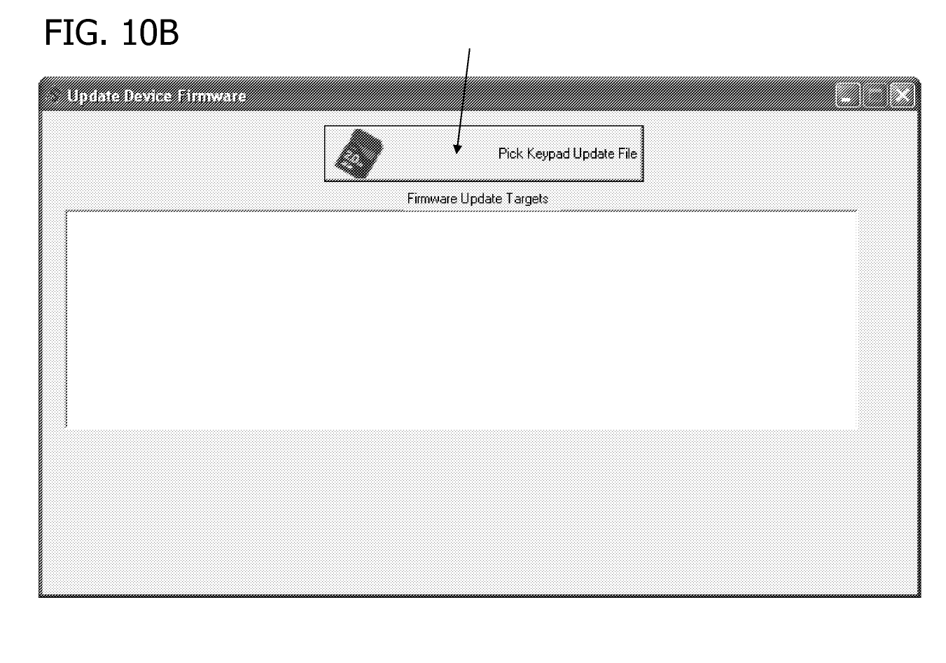

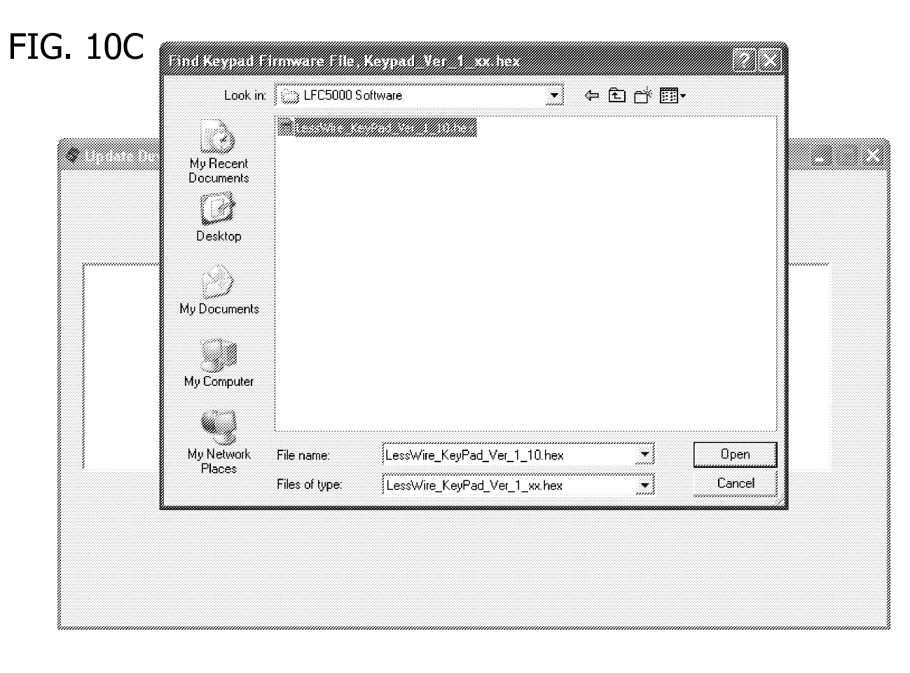

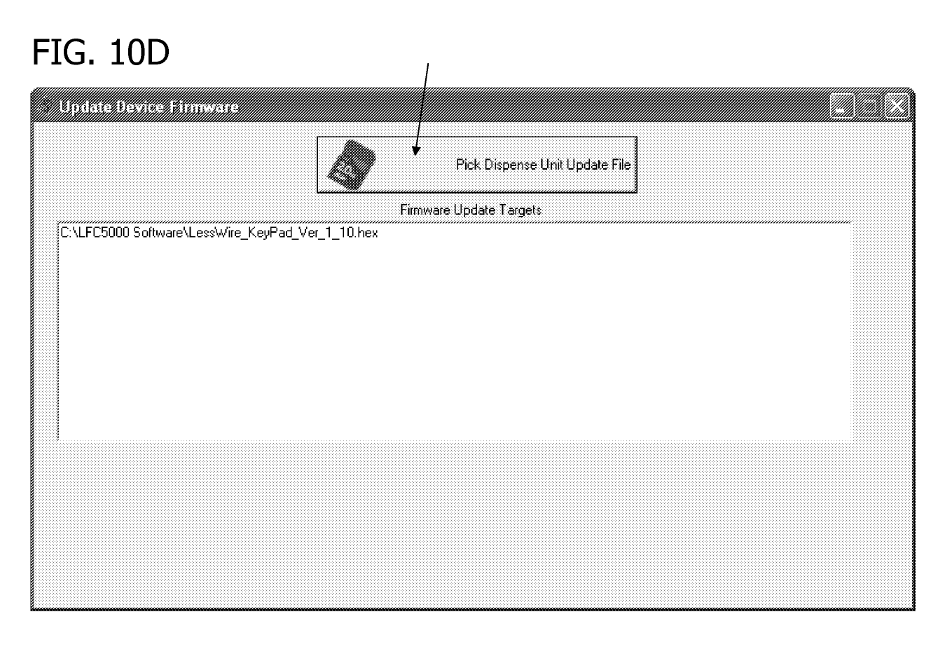

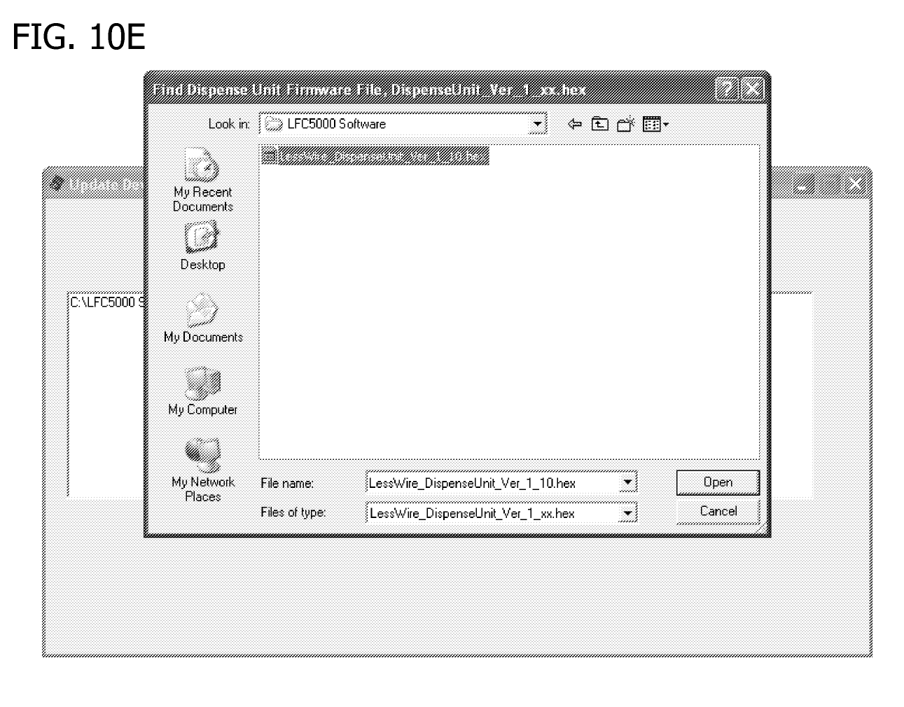

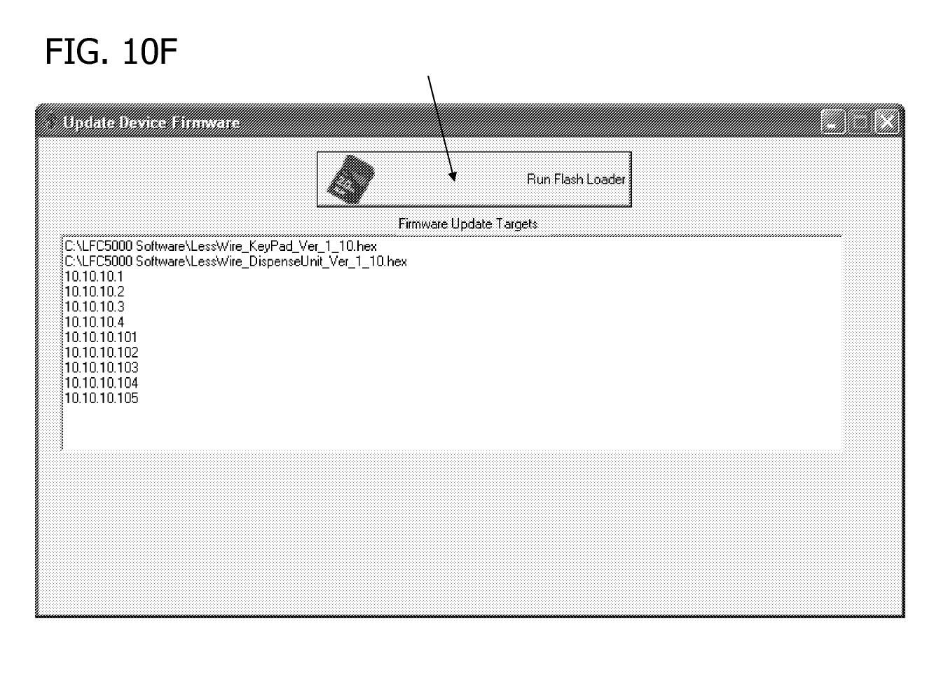

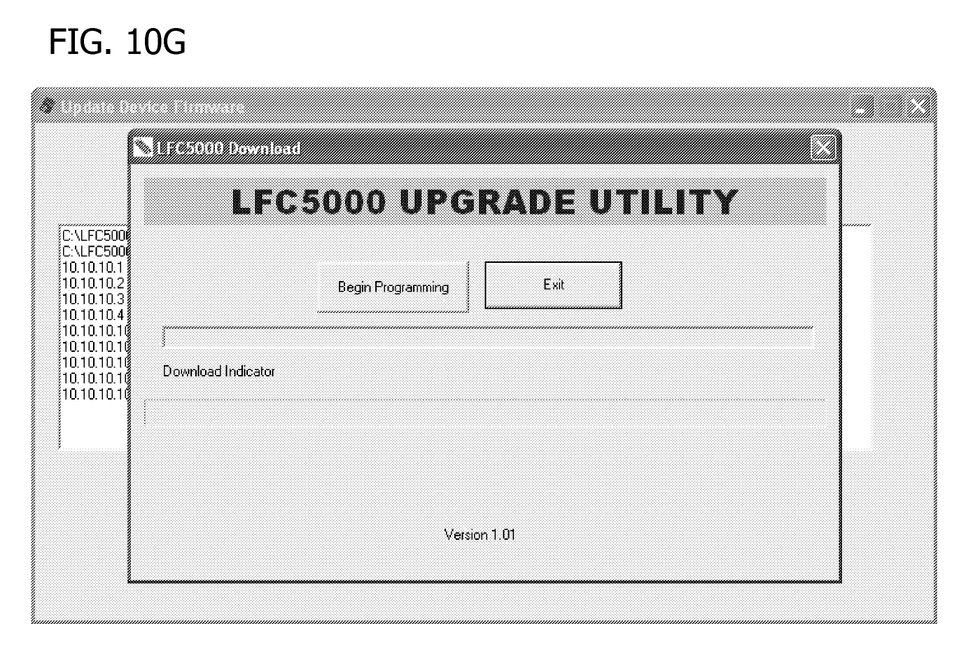

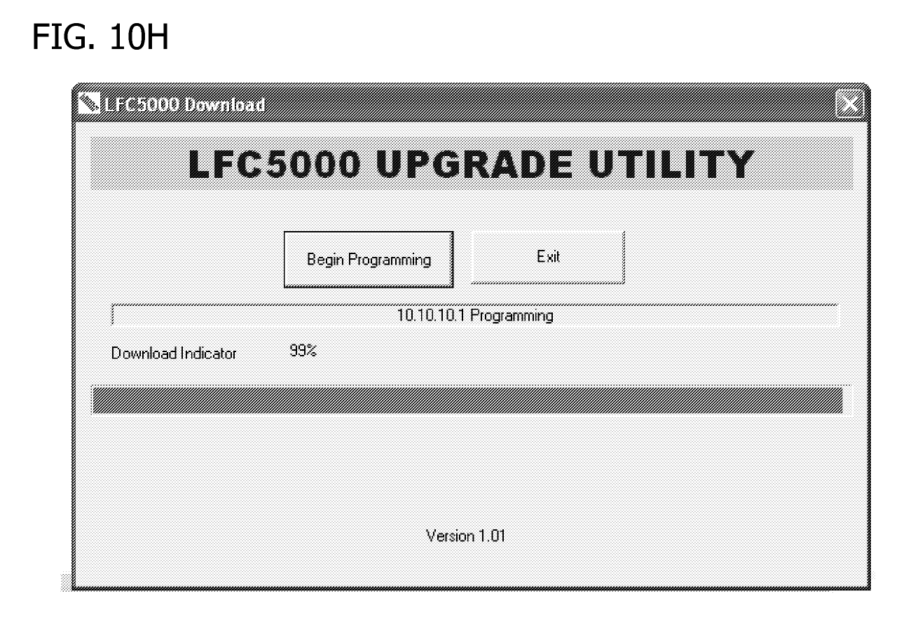

As noted below in FIGS. 9 and 10, the system further comprises self test software instructions executed by the master PC 116 to confirm the connections to the dispensing units 102 and to deliver software upgrades to the processor boards 118 of the dispensing units 102.

As illustrated in FIG. 2, the processor board 118 includes the I/O ports 120 providing signals for controlling the solenoid valves 108 for dispensing fluid. In addition, the processor board 118 has I/O ports 120 receiving signals from the pulse meter 110 or similar sensors indicating a volume of fluid dispensed by its associated solenoid valve 108. In addition, the processor board 118 includes the data port 132 for transmitting and receiving information to and from the master PC 116.

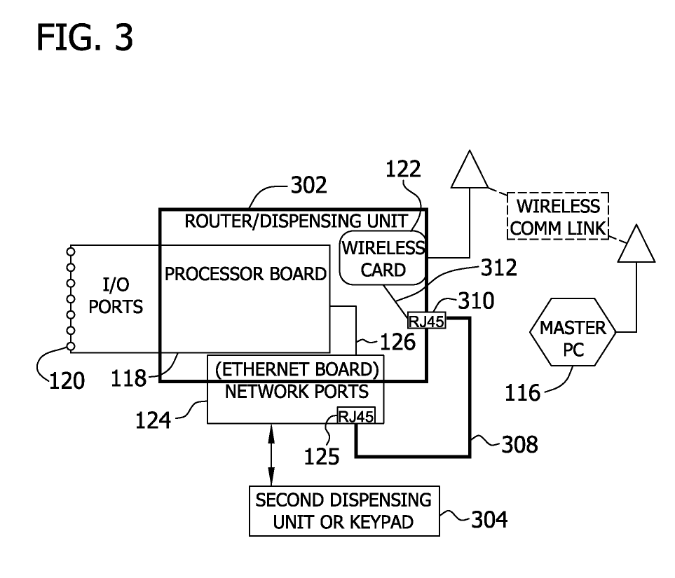

FIG. 3 is a block diagram of one embodiment of the dispensing unit 302 according to the invention in combination with a master PC 116 in which the dispensing unit 302 is configured to communicate with the master PC 116 via a wireless communication link. In addition, the dispensing unit 302 functions as a router for an Ethernet connection via hard-wire to a second dispensing unit or keypad 304. In this configuration, the connecting device 126 such as a CAT. 5 cable is positioned between the data port 132 of the processor board 118 and the data port 123 of the Ethernet board 124. In addition, an additional connecting device such as an Ethernet cable 308 is connected between the Ethernet board and the wireless card 122. As illustrated in FIG. 3, the dispensing unit is provided with a connector 310 which allows the cable 308 to be externally connected between the connector 310 and the Ethernet board 122. Additionally, a separate cable 312 would internally connect the wireless card 122 and the connector 310 within the housing of the dispensing unit 302.

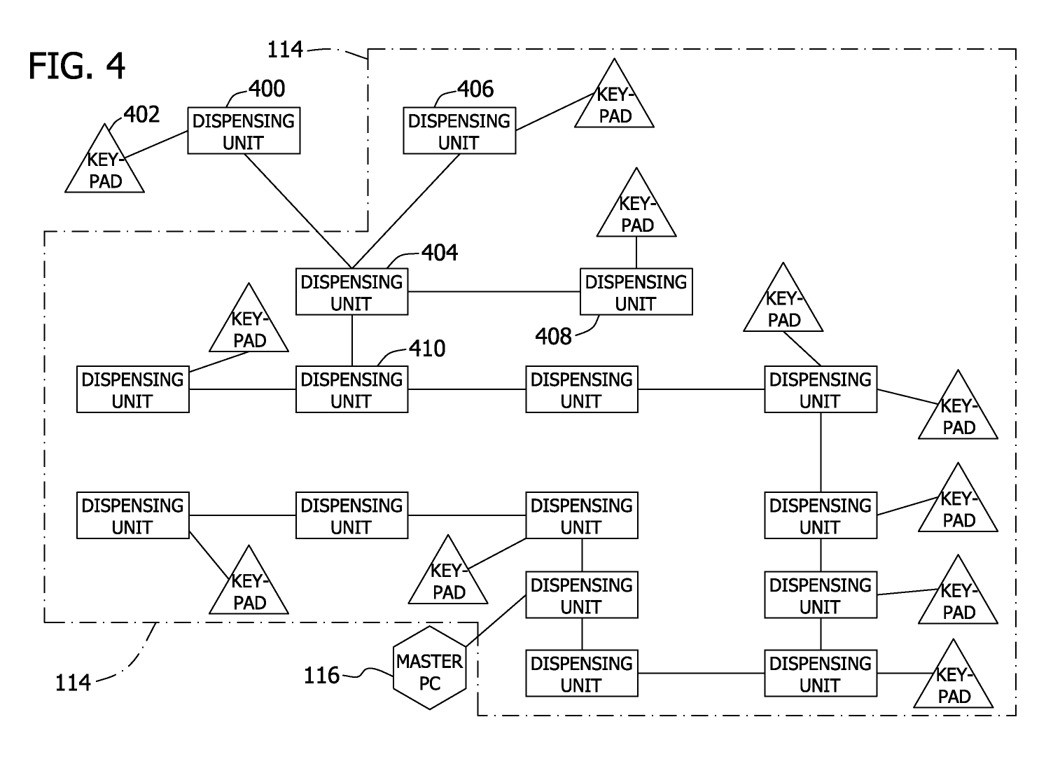

FIG. 4 is a block diagram of a system according to the invention in one embodiment which employs only a hard-wired Ethernet network illustrated by solid lines for interconnecting keypads 402, dispensing units 102 and the master PC 116. In this configuration, the keypads 402 are illustrated as networked via hard-wire to the dispensing units 102, that is, the keypads 402 are connected to the hard-wire ports of the Ethernet board 124 of the dispensing units 102. In this embodiment as illustrated in FIG. 4, the dispensing units 102 would be configured to have a CAT. 5 cable which connects the data port 132 of the processor board 118 to the data port 123 of the Ethernet board 124. It is contemplated that the Ethernet board 124 of each dispensing unit would have several hard-wire ports. For example, dispensing unit 400 of FIG. 4 shows that two hard-wire ports of the Ethernet board 124 would be used, one connected to the keypad 402 and the other connected to another dispensing unit 404 which is part of the network 114. Thus, dispensing unit 404 would have an Ethernet board 124 with at least four hard-wire ports, a first port for a hard-wired connection to the dispensing unit 400, a second port for a hard-wired connection to the dispensing unit 406, a third port for a hard-wired connection to dispensing unit 408, and a fourth port for a hard-wired connection to dispensing unit 410. In one embodiment according to the invention, it is contemplated that the Ethernet board 124 of each dispensing unit 102 of the network would have four hard-wire ports.

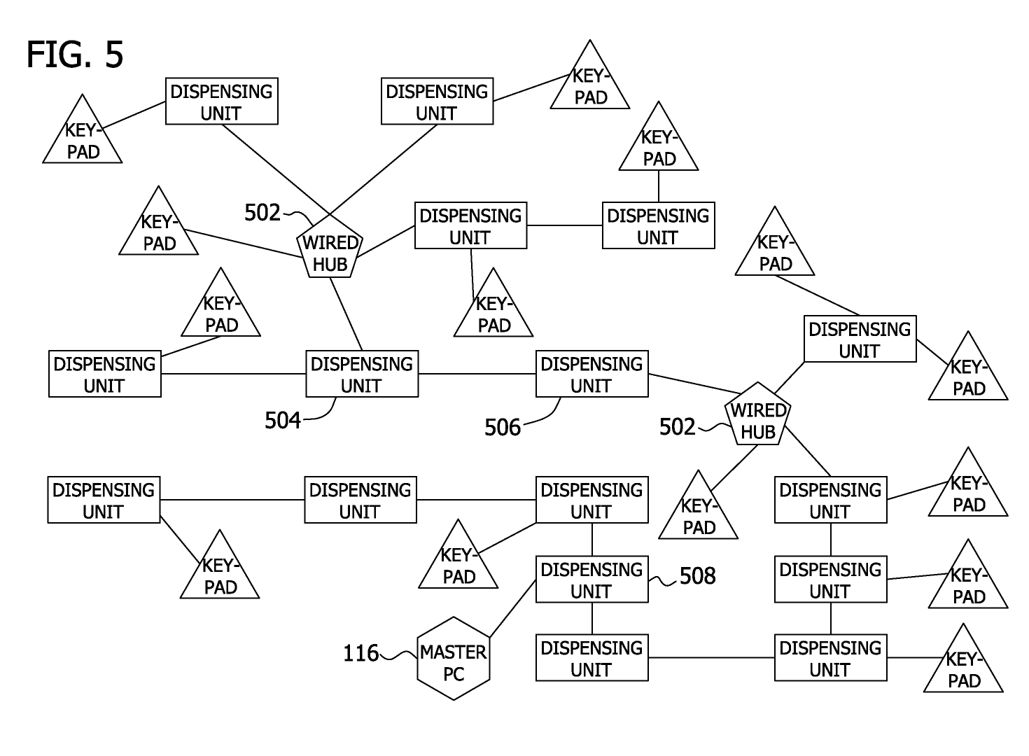

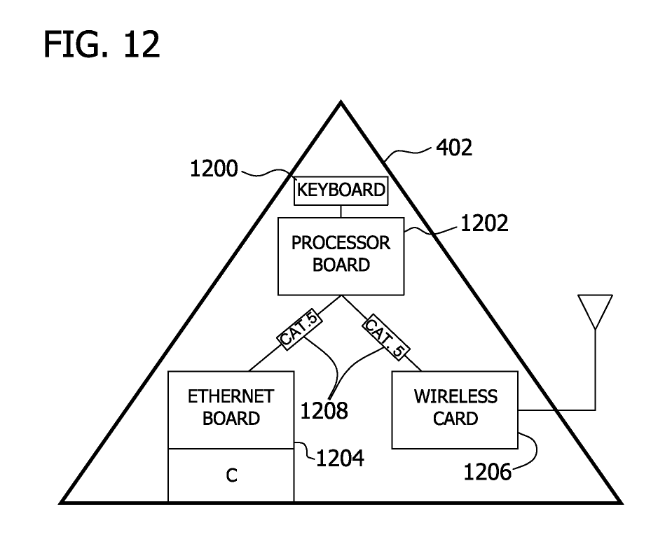

The following FIGS. 5-8 illustrate various hybrid configurations of a system according to the invention. The systems are referred to as hybrid because the systems employ both a hard-wired network and a wireless communications link to link the various pieces of hardware. In general, it is contemplated that any one piece of hardware may communicate with the network via other piece of hardware by either a hard-wire connection or a wireless link. For example, a hybrid keypad (see FIG. 12) may communicate via hard-wire connection to another keypad, to a dispensing unit or to a computer. As another example, a hybrid dispensing unit may communicate via hard-wire connection to a keypad, to another dispensing unit or to a computer. As another example, a computer may communicate via hard-wire connection to a keypad, to a dispensing unit or to another computer. Thus, FIGS. 5-8 are exemplary and are not intended to illustrate each and every configuration of the system of the invention.

FIG. 5 is a block diagram of another embodiment of the system according to the invention employing only a hard-wired Ethernet network to interconnect keypads dispensing units and the master PC. In this network configuration, a plurality of wired hubs 502, such as four (4) port hubs manufactured by LINKSYS or NETGEAR, are employed for interconnecting the dispensing units and the keypads. In general, it is contemplated that any number of ports per hub may be used. In this embodiment, the wired hubs 502 are an Ethernet hub having a plurality of Ethernet ports serving as a central location to which a plurality of dispensing units and/or a plurality of keypads may be connected. In this embodiment, the wired hubs 502 are linked by Ethernet hard-wired connections via dispensing unit 504 and dispensing unit 506. It is also contemplated that the wired hubs may be directly connected to each other and/or via a keypad. In addition, in this illustrated embodiment, the master PC 116 is shown connected to the network via a dispensing unit 508. It is also contemplated that the master PC may be directly connected to a wired hub 502 or to the network via a keypad.

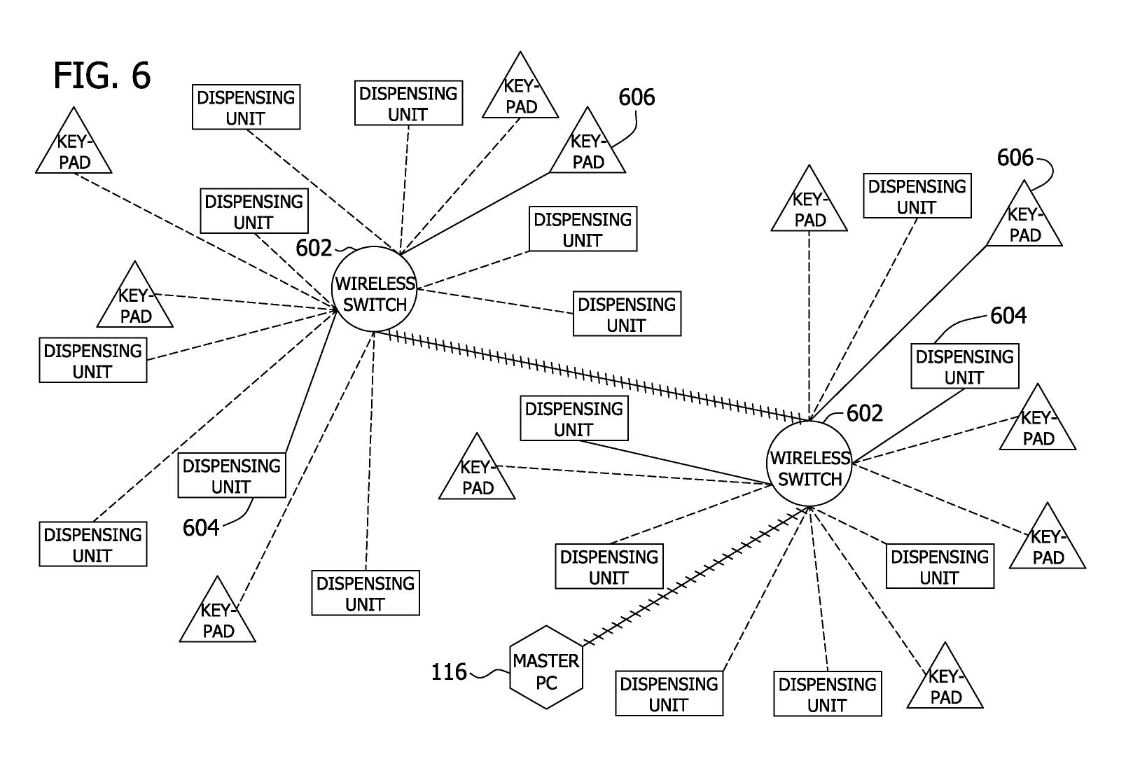

FIG. 6 is a block diagram of another embodiment of a system according to the invention. In this embodiment, wireless communication links illustrated by dashed lines and a hard-wired Ethernet network illustrated by solid lines are used to interconnect the keypads, dispensing units, and a master PC. In addition, this system employs wireless switches 602, such as four (4) port wireless switch manufactured by LINKSYS or NETGEAR, for interconnecting the various components of the network as illustrated in FIG. 6. For example, the wireless switches 602 would be routers which would communicate wirelessly via a WiFi network with each of the dispensing units and the keypads. In the system as shown in FIG. 6, the keypads and most of the dispensing units are networked via wireless communication links illustrated as dashed lines to the wireless switches 602. In the embodiment as illustrated in FIG. 6, each dispensing unit other than units 604 would have a connecting device such as a CAT. 5 cable which interconnects the data port 132 of the processor board 118 to the data port 121 of the wireless card 122. Similarly, the keypads other than keypads 606 would be configured so that the processor board 1102 would be connected to the Ethernet board 1104 via a CAT. 5 cable. However, two of the dispensing units 604 and two of the keypads 606 are networked via hard-wire shown as solid lines to the wireless switches 602. In units 604 and 606, the CAT. 5 cable 126, 1108 would connect the processor board 118, 1102 with the Ethernet board 124, 1108, respectively.

Thus, the wireless switches 602 would be a standard type of router which would include WiFi communication as well as an Ethernet board for hard-wire connections. Thus, this configuration provides flexibility in that a particular keypad or a particular dispensing unit may be alternatively connected to the wireless switch 602 via a wireless communication link or via a hard-wired Ethernet cable. As illustrated in FIG. 6, the wireless switches 602 are interconnected to each other and to the master PC 116 via a wideband wireless communication link indicated by slashed lines. However, it is also contemplated that the interconnections between the wireless switches and/or the master PC 116 could be via a wireless communication link or via hard-wired Ethernet network.

In general, only certain components can communicate with other components so that the interconnection between components is configured to facilitate this communication. For example, it may be preferable to configure the system such that the master PC only communicates with the wireless switches and not directly with the dispensing units. Once again, this system provides flexibility in that the particular location of the dispensing units and the keypads can be the most convenient location for each particular dispensing unit and keypad. Thereafter, the communication between the wireless switches and the master PC can be either configured wirelessly if the distance is not too great and there is no interference or via hard-wire if necessary.

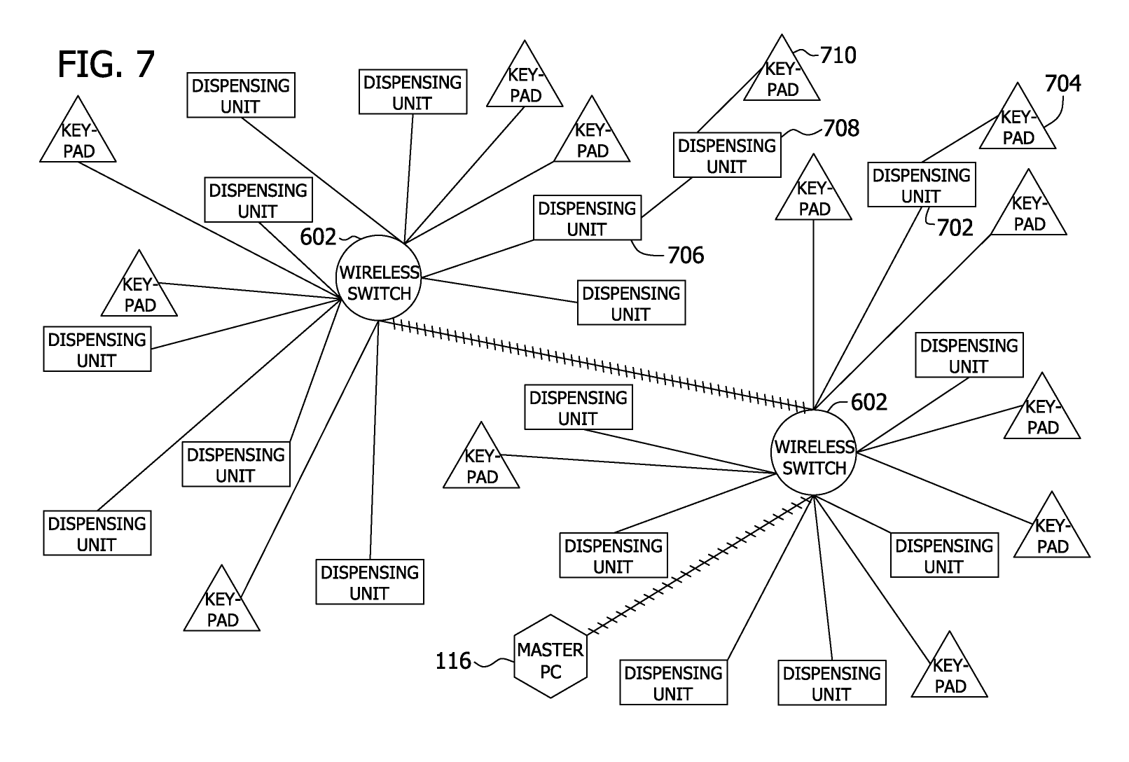

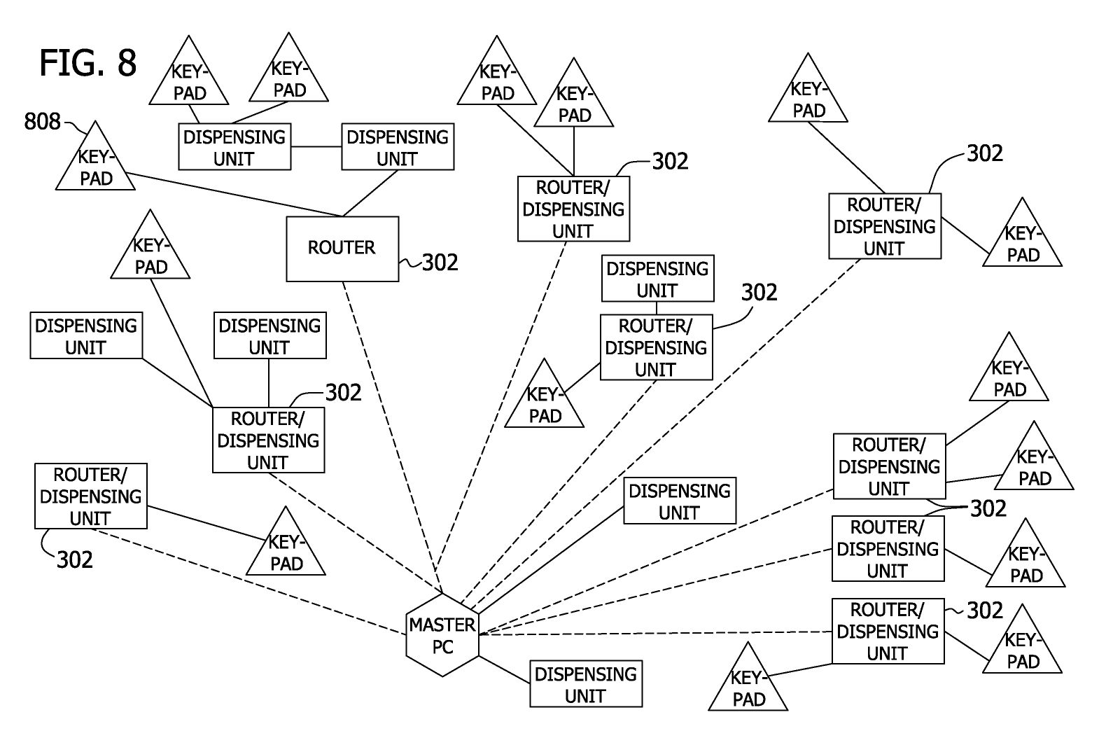

In the particular embodiment of FIG. 7, the keypads and dispensing units are networked via hard-wire illustrated by solid lines to the wireless switches 602 and the wireless switches and master PC are networked via a wideband wireless communication link illustrated by slashed lines. In addition, dispensing unit 702 has a keypad 704 hard-wired via Ethernet link to it. In addition, dispensing unit 706 has a dispensing unit 708 hard-wired via Ethernet link to it and also is hard-wired to a keypad 710. Once again, the flexibility of the system according to the invention is illustrated in FIG. 7 since the keypad 704 could be linked to the dispensing unit 702 via a wireless interconnection or a hard-wire connection. This aspect of the invention is illustrated in more detail in FIG. 8 where the dispensing units are configured according to FIG. 3.

As illustrated in FIG. 8, the router/dispensing unit 302 would be used in various embodiments. For example, FIG. 8 is a block diagram of a system of the invention employing both a wireless communication link and a hard-wired Ethernet network to interconnect keypads, dispensing units and a master PC. In this configuration, at least some of the dispensing units 302 are also configured in a router configuration as illustrated in FIG. 3 so that the dispensing unit 302 can communicate simultaneously via the hard-wired network and the Ethernet board 124 and via the wireless card 122 and the wireless communication link. In FIG. 8 some of the keypads and some of the dispensing units are networked to the router/dispensing units 302 via hard-wire Ethernet connections illustrated by solid lines. In addition, some of the keypads are networked to the dispensing units via hard-wire Ethernet connections. In addition, the router/dispensing units 302 and master PC are connected via the wireless communication link.

FIGS. 9A-9E are screen shots of one embodiment of software instructions executed by the master PC to confirm the connectivity to the dispensing units and keypads. FIG. 9A illustrates the main screen at which point a user would select “Configure System” as indicated by the arrow. FIG. 9B illustrates the resulting system configuration screen at which point the user would select “Hardware” as indicated by the arrow. FIG. 9C illustrates the resulting system configuration screen at which point the operator would place a check mark by each dispense unit and each keypad that has been installed in the system. The operator may then select “Test DU Network Connectivity” to test the connectivity to the dispensing units. The software on the master PC would then ping each dispensing unit. A number appearing in the “good” column would indicate successful communication with the associated dispensing unit and a number appearing in the “bad” column would indicate unsuccessful communication with the associated dispensing unit. Thus, FIG. 9D illustrates successful communication with dispensing units #1 and #2 (meaning these units responded to the ping) but unsuccessful communication with dispensing unit #3 (meaning this unit did not respond to the ping). Alternatively or in addition, at FIG. 9C, the operator may then select “Test Keypad Network Connectivity” to test the connectivity to the keypads. The software on the master PC would then ping each keypad. A number appearing in the “good” column would indicate successful communication with the associated keypad and a number appearing in the “bad” column would indicate unsuccessful communication with the associated keypad. Thus, FIG. 9E illustrates unsuccessful communication with keypads #1, #2 and #3 (meaning these keypads did not respond to the ping) and successful communication with keypad #4 (meaning this unit did respond to the ping).

FIGS. 10A-10H are screen shots of one embodiment of software instructions for uploading software to the dispensing units and keypads. FIG. 10A illustrates the main screen at which point a user would select “Install Firmware Updates” as indicated by the arrow. FIG. 10B illustrates the resulting update screen at which point the user would select “Pick Keypad Update File” as indicated by the arrow. FIG. 10C illustrates the resulting file screen at which point the user would navigate to the appropriate directory and select and open the file to be uploaded to the keypads. FIG. 10D illustrates the next update screen at which point the user would select “Pick Dispense Unit Update File” as indicated by the arrow. FIG. 10E illustrates the resulting file screen at which point the user would navigate to the appropriate directory and select and open the file to be uploaded to the dispense units. FIG. 10F illustrates the next update screen at which point the user would select “Run Flash Loader” as indicated by the arrow. The next screen at FIG. 10G implements the upgrade utility by selecting “Begin Programming.” The utility would then connect to each keypad and dispense unit, one at a time, and update the firmware of the unit. When the firmware update is completed for one unit, the utility connects to the next unit in the list. After the upload to all units is complete, the operator selects “Exit” at FIG. 10H.

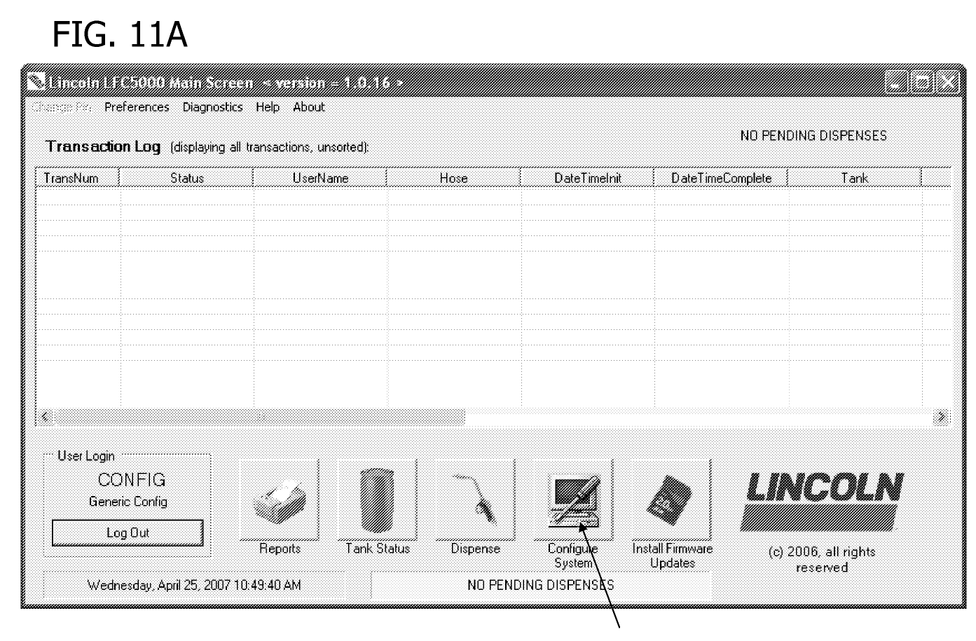

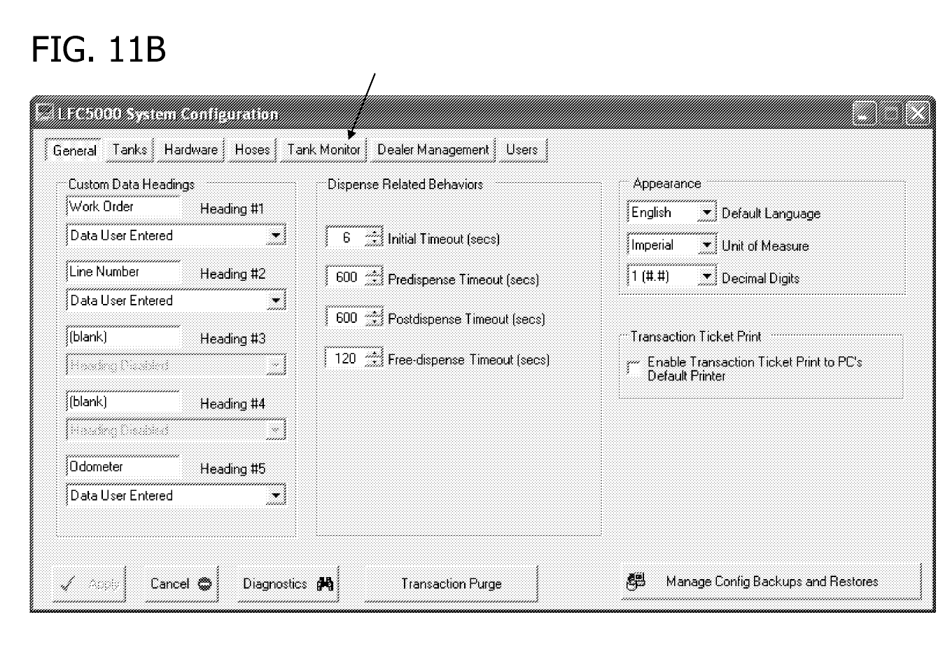

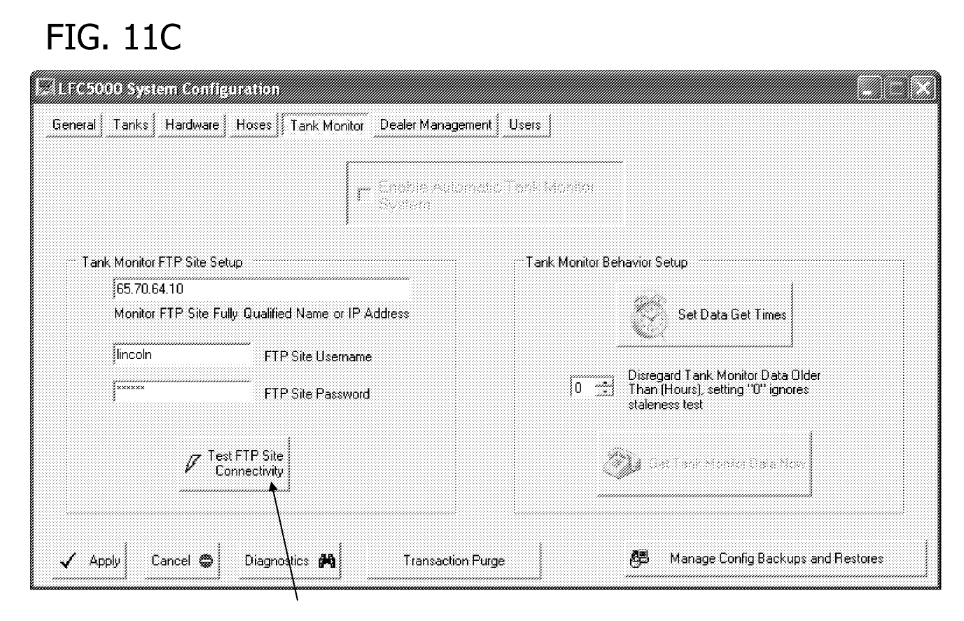

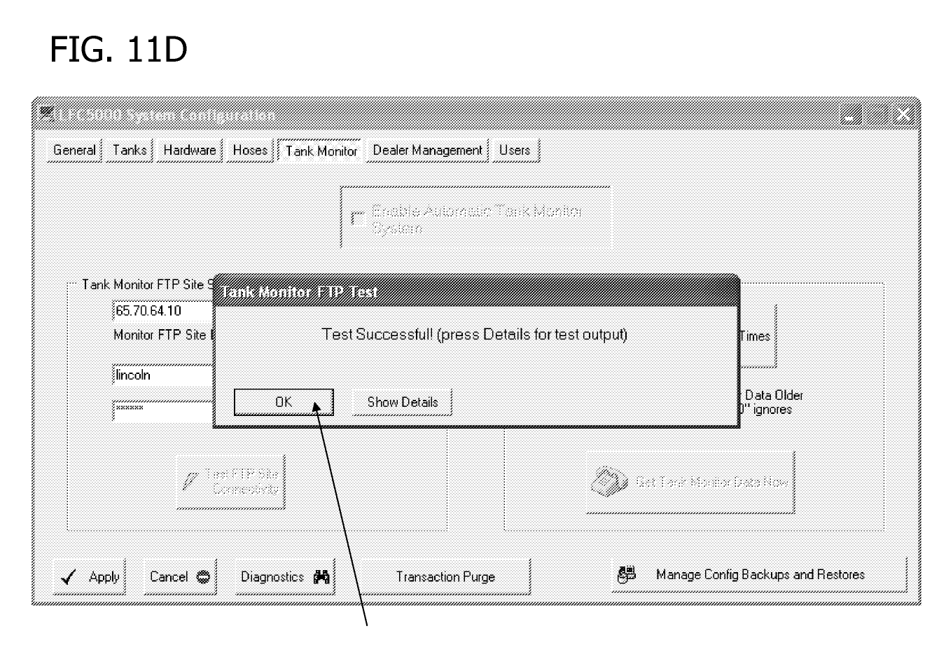

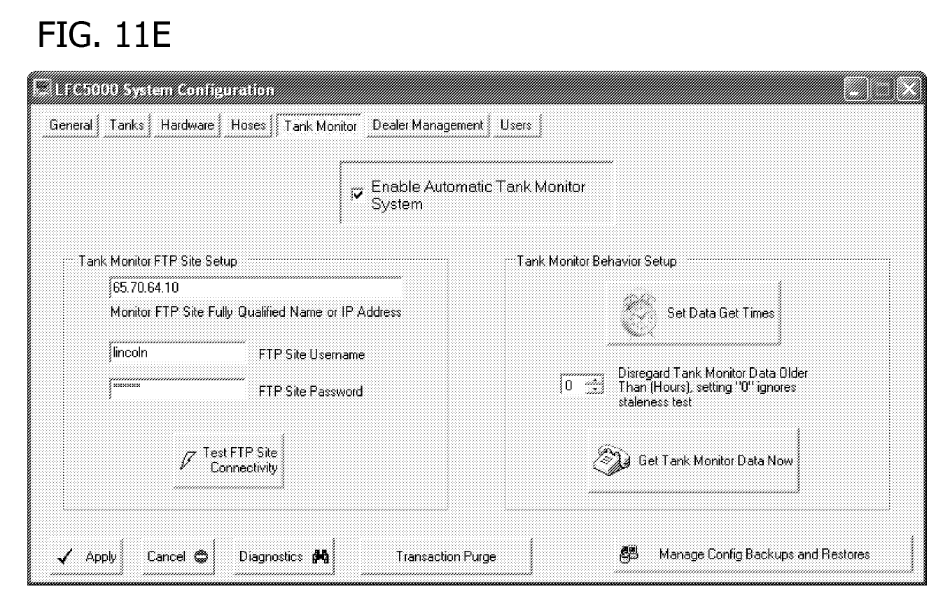

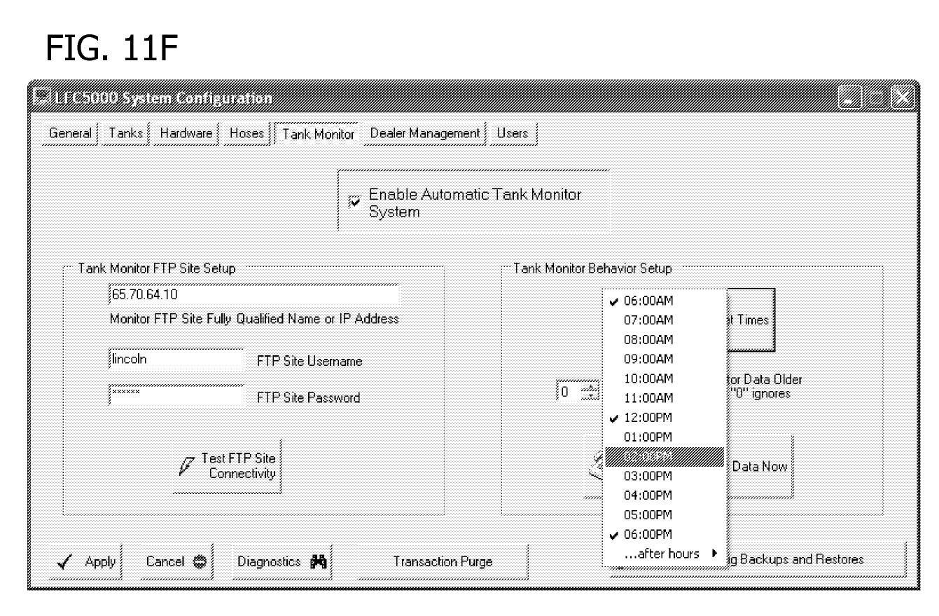

FIGS. 11A-11F are screen shots illustrating software instructions executed by the Master PC for accessing an ftp site providing tank monitoring information. In one embodiment, it is contemplated that one or more tanks at a location may be associated with a central unit for uploading tank levels to an ftp location. This allows monitoring of the tank levels. For example, a lubricant supplier can monitor tank levels to determine when tanks need to be refilled or replaced. Also, a dealership with several locations can consolidate tank levels from the various locations to permit efficient monitoring of lubricant levels and to permit bulk purchasing of lubricants.

Each tank to be monitoring is configured with one or more probes for reporting tank level to a central unit. The central unit periodically uploads tank levels (e.g., via cell phone or dial up) to an ftp site. FIGS. 11A-11F are screen shots illustrating software instructions for accessing the ftp site and downloading tank levels.

FIG. 11A illustrates the main screen at which point a user would select “Configure System” as indicated by the arrow. FIG. 11B illustrates the resulting system configuration screen at which point the user would select “Tank Monitor” as indicated by the arrow. FIG. 11C illustrates the resulting system configuration screen at which point the user would provide IP address of the site for the tank (“Tank Monitor FTP Site Setup”; e.g., 65.70.64.10), the “FTP Site Username” and the “FTP Site Password.” The user would then select “Test FTP Site Connectivity” as indicated by the arrow. FIG. 11D illustrates the resulting system configuration screen which indicates that the test was successful and the user would select “OK” as indicated by the arrow. FIG. 11E illustrates the resulting system configuration screen at which point the user would select “Enable Automatic Tank Monitor System” and “Set Data Get Times” as indicated by the arrows. FIG. 11F illustrates the resulting system configuration screen which allows the user to select times at which the tank level would be downloaded from the ftp site to the system. Alternatively or in addition, at shown in FIG. 1E, the user has the option of indicating the number of hours beyond which older tank data would be ignored. For example, if seven (7) hours was selected and an upload indicated that the uploaded data was seven (7) or more hours old, the data would be ignored. Setting this to “0” disables the staleness test and the last data regardless of age is uploaded. Alternatively or in addition, at shown in FIG. 1E, the user has the option of selecting “Get Tank Monitor Data Now” at which point the data immediately available would be downloaded from the ftp site to the system. At each selected time or when “Get Tank Monitor Data Now” is selected, the software queries the ftp site to determine tank levels and displays the tank levels on a tank status screen (not shown).

FIG. 12 illustrates one embodiment of a keypad 402 used by a mechanic or other individual to input information to control the various hose reels via the dispensing units. Keypad 402 is a hybrid unit and can be configured to communicate via a hard-wired Ethernet network or via a wireless communication network. Keypad 402 includes a keyboard 1200 connected to a processor board 1202 which can be selectively connected to either an Ethernet board 1204 or a wireless card 1206. Depending on the system configuration and depending on the location of the keypad, it may be more convenient to position the keypad 402 in a place where wireless communication is available in which case a connecting device such as CAT. 5 cable may be connected between the processor board 1202 and the wireless card 1206. Alternatively, in an area where there may be considerable WiFi communication interference, or WiFi is unavailable, it may be preferable to implement the keypad 402 as a hard-wired device. In this case, the CAT. 5 cable would interconnect the processor board 1202 and the Ethernet board 1204 and the keypad would be connected via Ethernet board 1204. In order to prevent cables from the solenoid valve 108 and pulse meter 110 to be connected to the Ethernet board 1204 of the keypad 402, the ports of the Ethernet board 1204 would have C type connectors which are the same as the C type connectors of the hard-wire ports of the Ethernet board 124 of the dispensing unit 102 (see FIG. 2). Thus, the hard-wired Ethernet cables 230 would be connectable to the keypad 402 whereas the hard-wired cables 212 for interconnecting between the I/O ports 120 and the solenoid valve 108 and pulse meter 110 via A type connectors would not be compatible with the C type connectors of the Ethernet board 1204 and could not be connected to the Ethernet board 1204. In use, a mechanic would enter a repair order number and instructions to deliver lubricant via a particular reel. As a result the appropriate solenoid valves 108 would be opened to permit lubricant delivery via use of the nozzle 112 by the mechanic.

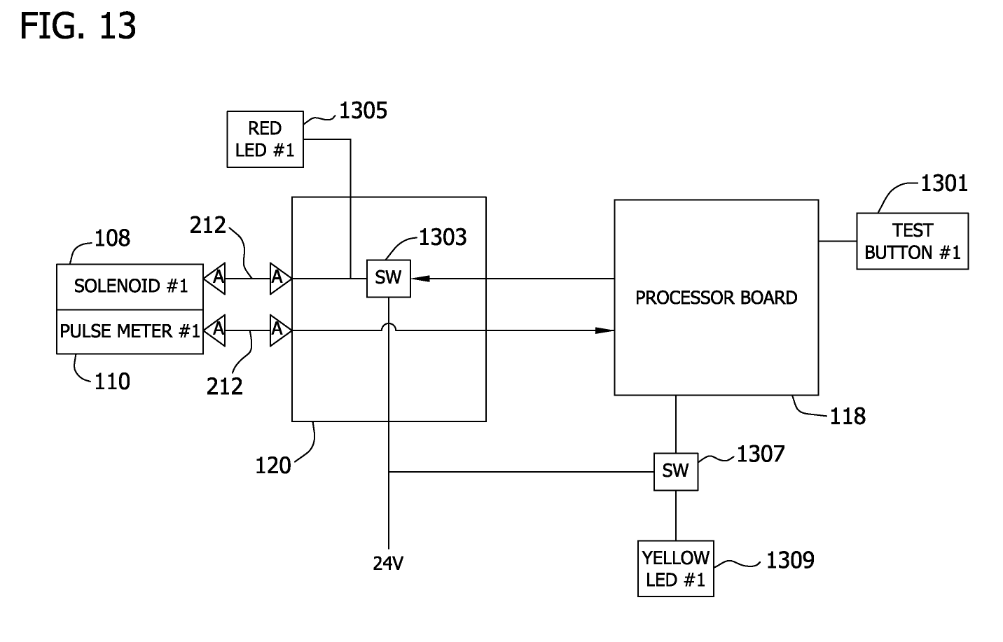

FIG. 13 illustrates one embodiment of a circuit for confirming the connections to one of the solenoids 108 and its associated pulse meter 110. A similar circuit may be used for each solenoid and its associated pulse meter. A test button #1 1301 is depressed by an installer or operator to indicate to the processor board that a test of solenoid #1 108 should be initiated. In response, the processor board closes a switch which selectively energizes the solenoid #1 to open a valve which supplies pressurized lubricant. When the switch 1303 closes, it illuminates a red LED #1 1305 visually confirming to the operator or installer that power is available to the solenoid #1. Assuming that the cable 212 electrically connects solenoid #1 to the I/O port 120, it should open a valve so that pressurized lubricant flows and activates the pulse meter #1 to provide a signal via cable 212 (if properly connected) to the I/O port 120 and the processor board 118. When the processor board 118 receives a pulsed signal from the pulse meter #1, it pulses a yellow LED #1 1309 by closing switch 1307 to indicate that the pulse meter 110 is energized. Thus, if cable 212 is properly connected to solenoid #1 108 and pulse meter #1 110, and if I/O 120 is functioning, when test button #1 1301 is pushed, both the red LED #1 1305 and the yellow LED #1 1309 will be illuminated. If cable 212 is not properly connected to solenoid #1 108 and pulse meter #1 110, or if I/O 120 is not functioning, when test button #1 1301 is pushed, either or both the red LED #1 1305 and the yellow LED #1 1309 will not be illuminated. Alternatively or in addition, a ready light (not shown) may be connected in parallel with the solenoid to confirm the cable connection between the I/O board and the solenoid.

In operation, a mechanic would use a keypad connected to the computer by wired or wireless communication to input a repair order which would include an invoice line for lubricant about to be dispensed by the mechanic. The mechanic would also use the keypad to input information identifying a particular hose reel supplying the type of lubricant to be dispensed. The input information would be provided to the computer which would communicate with the particular dispensing unit controlling the hose reel. In response, the dispensing unit would energize the solenoid to open the valve and allow the lubricant to flow. The mechanic would dispense the lubricant by controlling the nozzle of the hose reel and the pulse meter would sense the amount of lubricant dispensed, indicating the amount to the dispensing unit. The dispensing unit communicates the amount of lubricant dispensed to the computer which adjusts the repair order to include an invoice line for the dispensed lubricant.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A hybrid fluid dispensing control unit for use with a wired network interconnecting other fluid dispensing control units and a computer, and for use with a wireless communication device interconnecting other fluid dispensing control units and the computer, said hybrid fluid dispensing control unit comprising:
A processor having ports for controlling valves for dispensing fluid and having a data port for transmitting and receiving information;
A wired network board for connecting to the wired network and communicating with the other fluid dispensing control units;
A wireless communication device for communicating with the wireless communication device and communicating with the other fluid dispensing control units; and
A connecting device for selectively connecting the data port to one of the wired network board and the wireless communication device.

2. The unit of claim 1 having dip switches connected to the processor wherein the positions of the dip switches define a TCPIP address of the processor.

3. The unit of claim 1 wherein the processor, the wired network board, the wireless communication device and the connecting device are enclosed in a housing, said processor having I/O ports for interconnecting the processor to the valves for dispensing fluid and said wired network board having network ports for interconnecting the processor to the wired network data port and the computer.

4. The system of claim 1 wherein the output ports of the processor for controlling the valves have a first connector type, wherein the wired network board has ports for connecting to the wired network having a second connector type and wherein the first connector type is incompatible with the second connector type.

5. The hybrid fluid dispensing control unit of claim 1 wherein the connecting device connects the data port to the wired network board and a second connecting device connects the wired network board to the wireless communication device so that the unit is configured to operate as a router.

6. A fluid dispensing control system comprising a plurality of interconnected fluid dispensing control units, and a computer connected to at least one of the fluid dispensing control units by a wired network, each said fluid dispensing control unit comprising:
A processor having I/O ports for controlling valves for dispensing fluid and for receiving signals from sensors indicating a volume of fluid dispensed by a controlled valve, said processor having a data port for transmitting and receiving information;
A wired network board for connecting to the wired network and communicating with the computer and other dispensing units; and
A connecting device for connecting the data port to the wired network board.

7. The system of claim 6 further comprising keypads having a wired network board connected to the wired network for controlling the fluid dispensing control units.

8. The dispensing unit of claim 6 further comprising a testing circuit for confirming that the processor output ports are connected to valves and for confirming that the input ports are connected to sensors.

9. The system of claim 6 wherein each dispensing control unit supplies lubricant from a lubricant source, wherein a level of each of the lubricant sources is maintained at an ftp site and wherein the computer includes instructions for accessing then ftp site and to download the levels f the lubricant sources.

10. The system of claim 6 further comprising a wired hub or a wireless switch for interconnecting at least some of the units.

11. The system of claim 6 wherein the output ports of the processor for controlling the valves have a first connector type, wherein the wired network board has ports for connecting to the wired network having a second connector type and wherein the first connector type is incompatible with the second connector type.

12. The system of claim 6 further comprising at least one hybrid keypad comprising:
A plurality of keys;
A processor board connected to the keys and having a data port for transmitting and receiving information;
A wired network board for communicating with the computer via the wired network;
A wireless communication device for communicating with the computer via the wireless communication device; and
A connecting device for connecting the data port to either the wired network board or the wireless communication device.

13. The system of claim 6 further comprising self test software instructions executed by the computer to confirm the connections to the dispensing units and to deliver software upgrades to the dispensing units.

14. The unit of claim 6 wherein the processor, the wired network board, the wireless communication device and the connecting device are enclosed in a housing, said processor having I/O ports for interconnecting the processor to the valves for dispensing fluid and said wired network board having network ports for interconnecting the processor to the wired network data port and the computer.

15. A fluid dispensing control system comprising a plurality of fluid dispensing control units communicating with a computer, said system having a wired network and having a wireless communications network, at least some of said fluid dispensing control units each comprising:
A processor having output ports for controlling valves for dispensing fluid and having a data port for transmitting and receiving information;
A wired network board for communicating with the computer via the wired network; and
A connecting device for connecting the data port to the wired network board; and
at least some of said fluid dispensing control units each comprising:
A processor having output ports for controlling valves for dispensing fluid and having data port for transmitting and receiving information;
A wireless network communication device for communicating with the computer via the wireless communication network; and
A connecting device for connecting the data port to the wireless communication device.

16. The system of claim 15 further comprising self test software instructions executed by the computer to confirm the connections to the dispensing units and to deliver software upgrades to the dispensing units.

17. The system of claim 15 further comprising at least one hybrid fluid dispensing control unit comprising:
A processor having output ports for controlling valves for dispensing fluid and having a data port for transmitting and receiving information;
A wired network board for communicating with the computer via the wired network;
A wireless communication device for communicating with the computer via the wireless communication device; and
A connecting device for connecting the data port to either the wired network board or the wireless communication device.

18. The system of claim 15 further comprising at least one hybrid keypad comprising:
A plurality of keys;
A processor board connected to the keys and having a data port for transmitting and receiving information;
A wired network board for communicating with the computer via the wired network;
A wireless communication device for communicating with the computer via the wireless communication device; and
A connecting device for connecting the data port to either the wired network board or the wireless communication device.

19. The system of claim 15 wherein the output ports of the processor for controlling the valves have a first connector type, wherein the wired network board has ports for connecting to the wired network having a second connector type and wherein the first connector type is incompatible with the second connector type.

20. The system of claim 15 wherein the connecting device connects the data port to the wired network board and a second connecting device connects the wired network board to the wireless communication device so that the unit is configured to operate as a router.

21. The system of claim 15 further comprising a wired hub or a wireless switch for interconnecting at least some of the units.

22. The system of claim 15 wherein each dispensing control unit supplies lubricant from a lubricant source, wherein a level of each of the lubricant sources is maintained at an ftp site and wherein the computer includes instructions for accessing then ftp site and to download the levels of the lubricant sources.

23. The unit of claim 15 wherein the processor, the wired network board, the wireless communication device and the connecting device are enclosed in a housing, said processor having I/O ports for interconnecting the processor to the valves for dispensing fluid and said wired network board having network ports for interconnecting the processor to the wired network data port and the computer.

24. The dispensing unit of claim 15 further comprising a testing circuit for confirming that the processor output ports are connected to valves and for confirming that the input ports are connected to sensors.
